(19) United States
(12) Patent Application Publication
(10) Pub. No.: US 2007/0127634 A1
(43) Pub. Date: Jun. 7, 2007

(54) Call recording device

(76) Inventor: Akiyoshi Katsumi, Shiroishi-ku (JP)

Correspondence Address: MCDERMOTT WILL & EMERY LLP, 600 13TH STREET, N.W., WASHINGTON, DC, 20005-3096, US

(21) Appl. No.: 11/592,240

(22) Filed: Nov. 3, 2006

Related U.S. Application Data
(60) Provisional application No. 60/736,329, filed on Nov. 15, 2005.

(30) Foreign Application Priority Data
Nov. 4, 2005 (JP) P2005-321123

(51) Int. Cl. H04M 1/64

(52) U.S. Cl. 379/67.1

(57) ABSTRACT

This call recording device includes: a transmission signal processing unit that superimposes a probe signal on a transmitted voice signal; a reception signal processing unit that monitors a received voice signal and that detects the probe signal included in the received voice signal, and decides the onhook/offhook condition of the telephone in accordance with the probe signal thus detected; and a data transmission processing unit that executes recording process when the offhook condition is identified. The reception signal processing unit includes: a PSK demodulator that demodulates the received voice signal; a correlator that calculates a correlation value of the demodulated signal and a replica code pattern corresponding to the probe signal; and a decision processing unit that decides that the telephone is in the offhook condition if the integrated value of the correlation value is at least a prescribed threshold value.

### BACKGROUND OF THE INVENTION

1. Field of the Invention

The present invention relates to a call recording device that is connected to a telephone and that executes recording process of calls on the telephone.

2. Description of the Related Art

Recording devices that monitor the voice signal in the event of a call on a telephone circuit and that record this voice signal directly as an analogue signal or that record the voice signal after conversion to a digital signal are previously known (see for example: “Windows-compatible USB call recording system “My Logger”” [online], System K Company Ltd [retrieved 28 Oct. 2005], Internet<URL:http://www.systemk.co.jp/products/sapfone/index_{—}2.html>; “Simple convenient call recording system “Call Recording Plus”” [online], Technology Link Company Ltd, [retrieved 28Oct., 2005], Internet <URL:http://park7.wakwak.com/˜tlc/kinou.htm>; and “Network-compatible long-period recording system” [online], Sophia Systems Company Ltd [retrieved 28th Oct., 2005], Internet <URL: http://www.sophia-systems.co.jp/nvr/>). In such recording devices, a series of voice signals is recorded for each call, but voice signals are not recorded if no call is in progress, so it is necessary to detect the beginning and end of a call.

For example, in “Windows-compatible USB call recording system “My Logger””, it is stated that the start of a call is identified by sensing the dial tone or conversation from the voice signal and termination of a call is identified by sensing the “no recorded sound” condition after the call has been disconnected. Also, in “Simple convenient call recording system “Call Recording Plus””, it is stated that recording is commenced when the receiver is picked up, by detecting sidetone of the telephone. and that recording is stopped when the receiver is hanged up. In contrast, in “Network-compatible long-period recording system”, a recording device is disclosed wherein a hook sensor is incorporated in the telephone and start of recording is controlled in response to detection by this hook sensor.

### SUMMARY OF THE INVENTION

If the voltage level of a prescribed sound such as the dial tone or conversation was detected from the voice signal as described above, in some cases it was not possible to detect accurately start or termination of a call, if voice was cut off during the call or if the voice level was too low. Also, if sidetone of the telephone was detected, in some cases, when a telephone having a headset is used, the internal circuitry is continually energized even during offhook, so ambient noise picked up by the microphone may be detected as sidetone, tending to produce a spurious detection result that the call is continuing. On the other hand, if the telephone was provided with a sensor that detects the hook switch condition, the construction of the telephone became complicated and the problem arose that, depending on the type of telephone, difficulty was experienced in mounting the sensor.

Accordingly, an object of the present invention is to provide a call recording device capable of accurate control of recording process in accordance with the hook condition in the telephone and in which restrictions regarding the type of telephone with which the device may be used are minimized.

In order to solve the above problems, a call recording device according to the present invention that is connected with a telephone and that executes recording process of calls on this telephone comprises: a transmission signal processing unit that is connected with the transmission side communication circuit of the telephone and that superimposes a probe signal modulated by a prescribed modulation method on a transmitted voice signal in the telephone; a reception signal processing unit that is connected with the reception side communication circuit of the telephone, that monitors a received voice signal in the telephone, and that detects the probe signal included in the received voice signal, and decides the onhook/offhook condition of the telephone in accordance with the probe signal thus detected; and a recording processing unit that executes recording process when it is decided by the reception signal processing unit that the telephone is in an offhook condition, wherein the reception signal processing unit comprises: a demodulator that demodulates the received voice signal; a correlator that calculates a correlation value of the demodulated signal output by the demodulator and a replica signal corresponding to the probe signal generated by the transmission signal processing unit; and a decision processing unit that decides that the telephone is in the offhook condition if the correlation that is output from the correlator is at least a prescribed threshold value.

In this call recording device, by superimposing a probe signal on the transmitted voice signal of the telephone, this probe signal leaks into the received voice signal as sidetone and when this received voice signal is demodulated the correlation value of this demodulated signal with a replica signal of the probe signal is calculated and it is decided that the telephone is in the offhook condition if the correlation value is at least a prescribed threshold value. Then, based on this decision result, recording process is executed when the telephone is in the offhook condition, so, irrespective of the voice level during the call, the hook condition can be accurately detected and the change in sidetone level between the onhook condition and offhook condition can be reliably identified. Also, by adopting a mode in which connection is effected with the transmission side communication circuit and reception side communication circuit of the telephone, restrictions on the type of telephone to which the device can be applied can be minimized.

Preferably the reception signal processing unit further comprises: an analogue/digital converter that converts the received voice signal to a received digital signal; and a continuo signal generating unit that generates a continuo signal having a pre-derived code pattern and that modulates the continuo signal and superimposes the modulated signal on the received digital signal, the correlator further calculates the correlation value of the demodulated signal and the code pattern, and the decision processing unit decides that the telephone is in the offhook condition if the correlation value that is output from the correlator is a prescribed second threshold value or below.

If such a construction is provided, the correlation value of the demodulated signal obtained by demodulating the digital signal and the code pattern included in the continuo signal is calculated after converting the received voice signal to a digital signal and superimposing the modulated continuo signal on this digital signal, and if the correlation value is less than the second threshold value, an offhook condition is identified. In this way, a drop in detection accuracy produced by the received voice during a call during detection of the hook condition using the probe signal can be prevented by combining this with use of a continuo signal.

Also, the reception signal processing unit preferably further comprises a threshold value control unit that, when the telephone is in the offhook condition, sets the second threshold value to a second value between the output level of the correlator during onhook and the present output level of the correlator.

In this way, for example even in the case of a call wherein the voice or noise level is comparatively small so that the correlator output is on the large side, the threshold value for continuo signal detection can be set to a suitable value in accordance with the voice or noise level generated while offhook.

Furthermore, the probe signal is preferably a signal that is modulated by spread spectrum modulation. By using a probe signal that is modulated by such spread spectrum, there is no harsh effect on the received voice during the call, and interference of the call voice with hook condition detection can be prevented.

### BRIEF DESCRIPTION OF THE DRAWINGS

FIG. 1 is a view showing the construction of a call recording system including a call recording device according to a suitable embodiment of the present invention;

FIG. 2 is a block diagram of the transmission signal processing unit of FIG. 1;

FIG. 3 is a view showing the construction of the code generator of FIG. 2;

FIG. 4 is a block diagram of the reception signal processing unit of FIG. 1;

FIG. 5 is a flow chart showing calibration process by the transmission level determining unit of FIG. 1;

FIG. 6 is a flow chart showing calibration process by the transmission level determining unit of FIG. 1; and

FIG. 7 is a view showing the construction of a call recording system including a call recording device constituting a test device.

### DESCRIPTION OF THE PREFERRED EMBODIMENTS

A preferred embodiment of a call recording device according to the present invention is described in detail below with reference to the drawings. In the following description, identical or corresponding parts are given the same reference symbols, to avoid duplicated description.

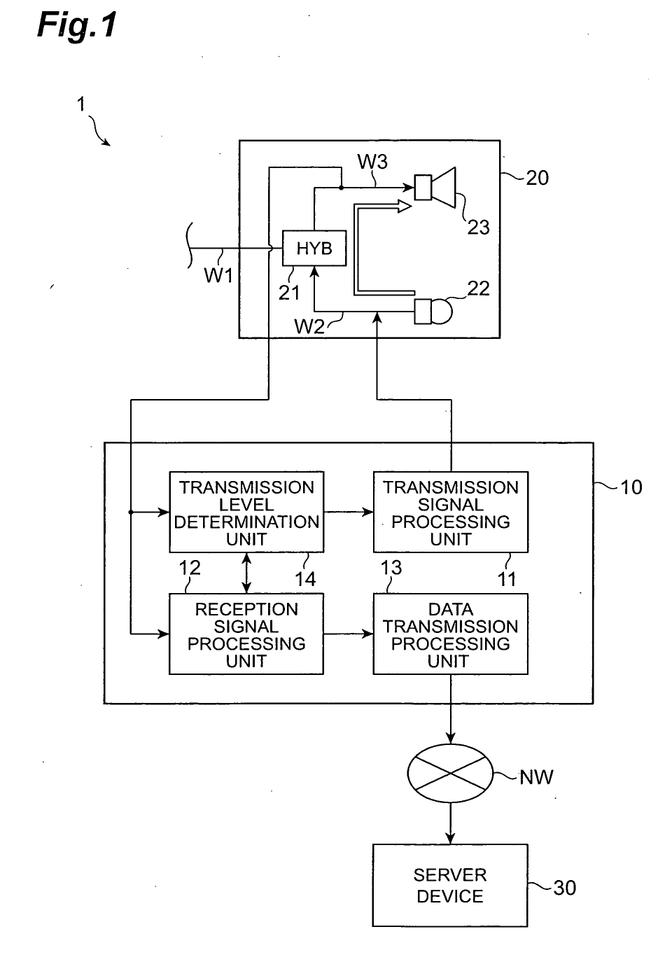

FIG. 1 is a view showing the construction of a call recording system 1 including a call recording device 10 according to a preferred embodiment of the present invention. As shown this FIGURE, the call recording system 1 is constituted including: a telephone 20 that performs communication in respect of calls that are to be recorded; a call recording device 10 that is connected with a telephone 20; and a server device 30 that is connected through a network NW such as a LAN (local area network) or WAN (wide area network) with the call recording device 10.

The telephone 20 comprises a hybrid circuit 21 that is connected with an external two-wire type telephone circuit W1; a transmitter 22 that is connected through a transmission side communication circuit W2 within the telephone 20 with the hybrid circuit 21; and a receiver 23 that is connected through a receiving side communication circuit W3 within the telephone 20 with the hybrid circuit 21. The hybrid circuit 21 transmits voice signals received from outside on the two-wire type telephone circuit W1 as received voice signals to the reception side communication circuit W3 and transmits on the telephone circuit WI transmitted voice signals that are received through the transmission side communication circuit W2 from the transmitter 22. Specifically, the hybrid circuit 21 is a so-called two-wire/four-wire conversion circuit that separates or combines analogue signals constituting transmitted voice or received voice between the four-wire type telephone circuit in the telephone 20 and the two-wire type telephone circuit outside the telephone 20. In this case, part of the transmitted voice signal transmitted from the transmitter 22 of the telephone 20 leaks to the reception side communication circuit W3 as “sidetone” through the hybrid circuit 21. “Sidetone” refers to sound that is generated as a result of some of the sound entering the receiver or noise from the surroundings of the telephone being output from the receiver after passing through the internal circuitry of the telephone.

The call recording device 10 comprises: a transmission signal processing unit 11 that is connected with the transmission side communication circuit W2 of the telephone 20 and that generates a probe signal by a prescribed modulation method and superimposes the probe signal on the transmitted voice signal in the telephone 20; a reception signal processing unit 12 that is connected with the reception side communication circuit W3 of the telephone 20, and monitors the received voice signal to detect the probe signal and identifies the hook condition of the telephone 20 in accordance with the detection result; a data transmission processing unit (recording processing unit) 13 that executes recording process of the received voice signal in accordance with the decision made by the reception signal processing unit 12; and a transmission level determination unit 14 that determines the signal level of for example the probe signal at a suitable level.

The server device 30 is a server system that performs for example reception voice data for each call transmitted from the data transmission processing unit 13 of the call recording device 10, creation of a voice file, construction of a database, and accumulation of voice files.

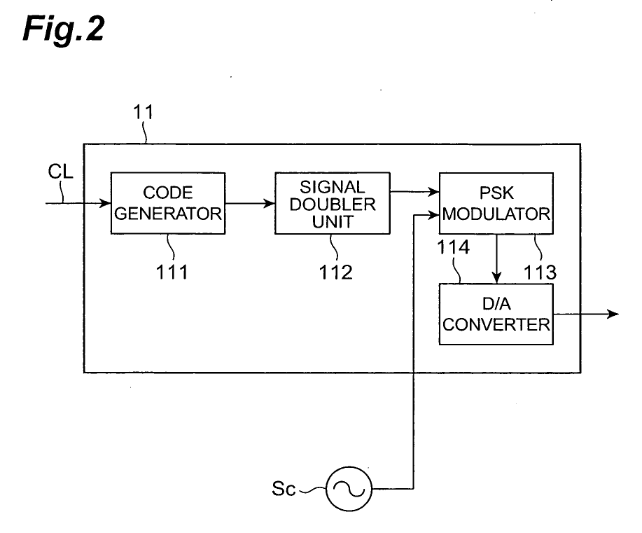

The various structural elements of the call recording device 10 will now be described with reference to FIG. 2 to FIG. 4.

As shown in FIG. 2, the transmission signal processing unit 11 comprises a code generator 111, signal current doubler unit 112, PSK modulator 113 and D/A converter 114.

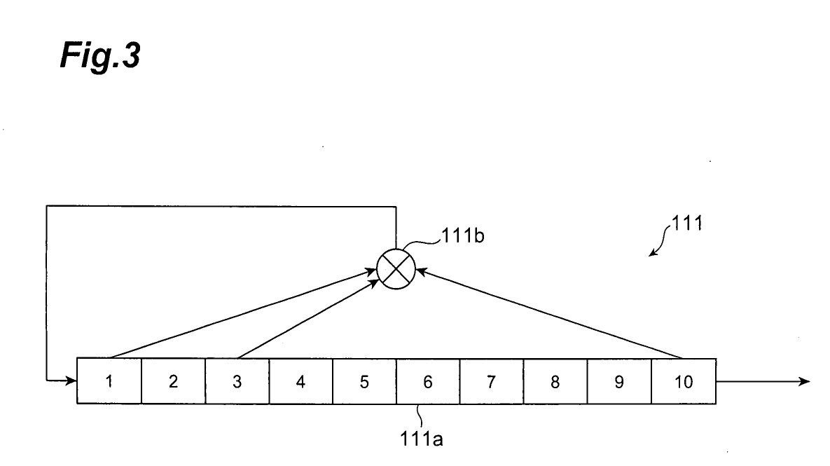

The code generator 111 is synchronized with a timing clock CL that is input from outside, and comprises a function of deriving a digital code sequence for generating a probe signal. As the call recording device 10, a direct sequence (DS) modulation system, which is one type of spread spectrum modulation system, is employed as a method of modulating the probe signal. The energy of the probe signal that is modulated in this way by direct sequence modulation is spread over a wide bandwidth, so this has benefits in terms of signal concealment and noise resistance, and, in addition, has the following advantages. Specifically, even though this probe signal is superimposed on the received voice signal, it has no harsh effect on the user, there is little interference with detection of the probe signal by voice signal during the call, and, even if the sidetone level is low, the detection sensitivity is high. Specifically, the code generator 111 generates an M sequence spread spectrum code by using the following formula (1):

[formula 1]
X¹⁰+X³+1 (1)
for the generating polynomial for generating the digital code sequence. As shown in FIG. 3, the code generator 111 comprises a shift register 111a of n stages (where, in this case, n=10), and a logic circuit 111b that feeds back the logical combination of the conditions of the plurality of stages of the shift register 111a to the input of the shift register 111a in accordance with the generating polynomial of formula (1).

The M sequence spread spectrum code that is thus generated is a code sequence repeated with a period of 2ⁿ 1, and has the properties that: the difference in the number of 1's and 0's in each period is no more than 1 (balance characteristic); when one sequence and a sequence obtained by shifting this by an arbitrary number are compared, the difference in the number of places where there is mutual agreement of the sequences and the number of places where there is mutual disagreement is no more than 1 (correlation characteristic); if there is one run (consecutive numbers with the same digit) in each period, the number thereof is ½ of the total number of runs, if there are two such runs, the number thereof is 1/4, and if there are three such runs, the number thereof is ⅛ (run characteristic), and if the exclusive OR of two arbitrarily shifted M sequence spread spectrum codes is taken, an M sequence spread spectrum code of different phase shift from either of these is obtained (generic characteristic).

Returning to FIG. 2, the signal doubler unit 112 doubles the M sequence spread spectrum code by replacing the digital values “0” of the M sequence spread spectrum code generated by the code generator 111 by “−1” and outputs the results to the PSK modulator 113.

The PSK modulator 113 generates a probe signal by modulating the carrier wave that is output from the carrier signal source S_{c} by PSK (phase shift keying) modulation, using the M sequence spread spectrum code. Specifically, the PSK modulator 113 executes processing to multiply the carrier signal with the spread spectrum code sequence.

The D/A converter 114 converts the probe signal that is output from the PSK modulator 113 from a digital signal to an analogue signal and superimposes the converted analogue signal on the transmitted voice signal by sending this to the transmission side communication circuit W2 of the telephone 20.

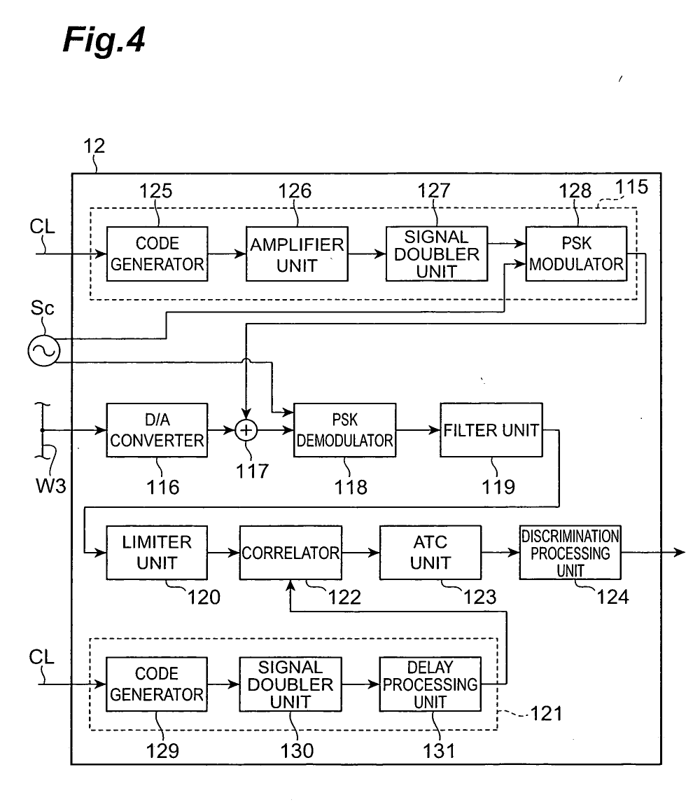

As shown in FIG. 4, the reception signal processing unit 12 comprises: a continuo signal generating unit 115 that generates a continuo signal that is combined with the probe signal for detecting the hook condition of the telephone 20; an A/D converter (analogue/digital converter) 116; an adder 117; a PSK demodulator 118; a filter unit 119; a limiter unit 120; a replica signal generating unit 121 that generates a replica signal (copy signal) corresponding to the continuo signal generated by the continuo signal generating unit 115; a correlator 122; an ATC unit (threshold value control unit) 123; and a decision processing unit 124.

The continuo signal generating unit 115 comprises. a code generator 125; an amplifier unit 126; a signal doubler unit 127; and a PSK modulator 128. This code generator 125 has the same construction and function as the code generator 111 and generates a digital code sequence for generating a continuo signal, synchronized with the timing clock CL. Specifically, the code generator 125 generates an M sequence spread spectrum code that does not interfere with the code sequence generated by the code generator 111 by using for example the following formula (2):

[formula 2]
X¹⁰+X⁹+X⁴+X²+1 (2)
as a generating polynomial for generating a digital code sequence in direct spread spectrum modulation. The “continuo signal” is a signal that is superimposed on the received digital signal obtained by subjecting the received voice signal to analogue/digital conversion and is used in combination with the probe signal for detecting the hook condition of the telephone 20. The signal doubler unit 127 and PSK modulator 128 respectively perform the same processing as the signal doubler unit 112 and PSK modulator 113. The amplifier unit 126 executes variable multiplication processing on the spread spectrum code sequence that is output by the code generator 125 and outputs the result to the signal doubler unit 127. In more detail, the amplifier units 126 performs multiplication processing using Q15 format fixed decimal calculation.

The A/D converter 116 obtains the received digital signal by performing analogue/digital conversion on the monitored received voice signal from the reception side communication circuit W3 of the telephone 20, and outputs the result to the adder 117. This received digital signal is added to the continuo signal by the adder 117 and input to the PSK demodulator 118.

The PSK demodulator 118 performs demodulation processing on the received digital signal including the continuo signal to extract the code sequence modulated by PSK modulation as a demodulated signal and outputs the result to the filter unit 119. Specifically, the PSK demodulator 118 performs synchronous detection by performing multiplication process of the carrier signal from the carrier signal source S_{c} that is input to the PSK modulators 113, 128 and the received digital signal, to obtain a demodulated signal.

The filter unit 119 performs smoothing process by the moving average method in order to remove high band signal components from the demodulated signal extracted by the PSK demodulator 118 and outputs the result to the limiter unit 120. In this smoothing processing, a Nyquist filter may be employed, but, in this case, with a view to simplification of processing, the moving average method is employed. For example, in the case where the bit rate of the code is 1 kHz with a sampling frequency of 8 kHz of the modulated signal, the filter unit 119 executes averaging process eight times.

The limiter unit 120 performs positive/negative discrimination processing on the data including the demodulated signal, and outputs the result to the correlator 122. In this positive/negative discrimination processing, the data of the codes in the demodulated signal is evaluated as “1” in the case where this is greater than 0, and is evaluated as “−1” in the case where the data of the codes in the demodulated signal is less than 0, so as to thereby generate a demodulated code sequence by removing amplitude noise components contained in the demodulated signal.

The replica signal generating unit 121 comprises. a code generator 129, signal doubler unit 130, and delay processing unit 131. The function of this code generator 129 and signal doubler unit respectively the same as that of the code generators 111, 125 and signal doubler units 112, 127 and this code generator 129 and signal doubler unit 130 generate both a replica code pattern (replica signal) constituting a code sequence that is the same as the spread spectrum code sequence corresponding to the probe signal and a replica code pattern that is the same code sequence as the spread spectrum code sequence corresponding to the continuo signal. The two replica code patterns generated by the code generator 129 and signal doubler unit 130 are synchronized with the spread spectrum code sequence included in the demodulated code sequence, so delay is applied thereto by the delay processing unit 131 corresponding to the delay time caused by for example the conversion process and sampling process of the transmission signal processing unit 11 and the reception signal processing unit 12, before these are output to the correlator 122.

The correlator 122 calculates the respective correlations of the demodulated code sequence and the replica code pattern corresponding to both the probe signal and the continuo signal, for one period. Specifically, the correlator 122, taking the demodulated code sequence as X₁(n) and the replica code pattern as X₂(n), finds the correlation φ(m) by the following formula (3):

$$[ formula 3 ] \\ ϕ ( m ) = \frac{1}{N} {\sum }_{n = 0}^{N - 1} {X}_{1} ( n ) {{X}_{2} ( n + m )}_{mod N} 0 < m \leq N - 1 \qquad ( 3 )$$

where X₂(n+m)_{modN} indicates a cyclic shift calculation performed on the data of N points. The correlator 122 additionally calculates the integrated value for one period of the correlation φ₁(m) calculated corresponding to the probe signal and the integrated value for one period of the correlation φ₂(m) calculated corresponding to the continuo signal, and outputs these integrated values to the discrimination processing unit 124 through the ATC unit 123.

The discrimination processing unit 124 identifies the onhook/offhook conditions of the telephone 20 in accordance with the respective integrated values of the correlations φ₁(m) and φ₂(m) that are output from the correlator 122, and outputs the discrimination result data to the data transmission processing unit 13. Specifically, if the integrated value of the correlation φ₁(m) is at least a prescribed threshold value φₜₕ₁, it is concluded that the probe signal is leaking into the received voice signal, so the hook condition of the telephone 20 is “offhook”: on the other hand, if the integrated value of the correlation φ₁(m) is less than the threshold value φₜₕ₁, it is concluded that the hook condition of the telephone 20 is “onhook”.

Since, if only the probe signal is detected, there is a possibility of detection becoming impossible due to voice interference with the probe signal during a call, the discrimination processing unit 124 performs detection in which priority is given to detection of the continuo signal, after offhook has been detected by means of the integrated value of the correlation φ₁(m). The continuo signal is a signal that is virtually injected with a fixed level in the circuit on the receiver side, so, by continually monitoring this signal, it is possible to detect the drop in detection sensitivity produced by superimposition of the probe signal or received voice signal from the side of the receiver 22 during offhook. The input condition is identified by means of the change in this detection sensitivity. Specifically, if the integrated value of the correlation φ₂(m) is less than the prescribed threshold value φₜₕ₂, the discrimination processing unit 124 concludes that a voice signal or probe signal is included in the received voice signal and therefore concludes that the hook condition of the telephone 20 is “offhook”: on the other hand, if the integrated value of the correlation φ₂(m) exceeds the prescribed threshold value φₜₕ₂, the discrimination processing unit 124 concludes that the hook condition of the telephone 20 is “onhook”.

The ATC unit 123 automatically sets the threshold values φₜₕ₁, φₜₕ₂ for detecting the hook condition of the telephone 20 in accordance with the respective integrated values of the correlations φ₁(m) and φ₂(m) that are output from the correlator 122 and outputs these to the discrimination processing unit 124. For example, whilst the discrimination processing unit 124 identifies an onhook condition, the threshold value φₜₕ₂ is set to a set value that is a prescribed ratio (for example ½) of the maximum output level of the integrated value of the correlation φ₂(m); and whilst the discrimination processing unit 124 identifies an offhook condition, the threshold value φₜₕ₂ is set to a value intermediate between the maximum output level of the integrated value of the correlation φ₂(m) and the output level of the integrated value of the present correlation φ₂(m). In ordinary telephones, sidetone is fairly well suppressed even in the offhook condition, due to the effect of the noise canceller or echo canceller, so the level difference of the output of the correlator 122 tends to be small. By control of the threshold value as described above, control is performed such as to raise the threshold value in such cases, so the threshold value for continuo signal detection can be set to a suitable value in accordance with the voice or noise level generated during offhook and during onhook.

Returning to FIG. 1, based on the discrimination result that is output from the reception signal processing unit 12, the data transmission processing unit 13 initiates recording process of a call on the telephone 20 with a timing matching the timing of change of the telephone 20 from the onhook condition to the offhook condition, and discontinues recording process with a timing matching the timing of change of the telephone 20 from the offhook condition to the onhook condition. This recording processing is performed by creating voice data based on the voice signal of the call that has been monitored. The data transmission processing unit 13 then successively transmits the voice data that has thus been generated to the server device 30.

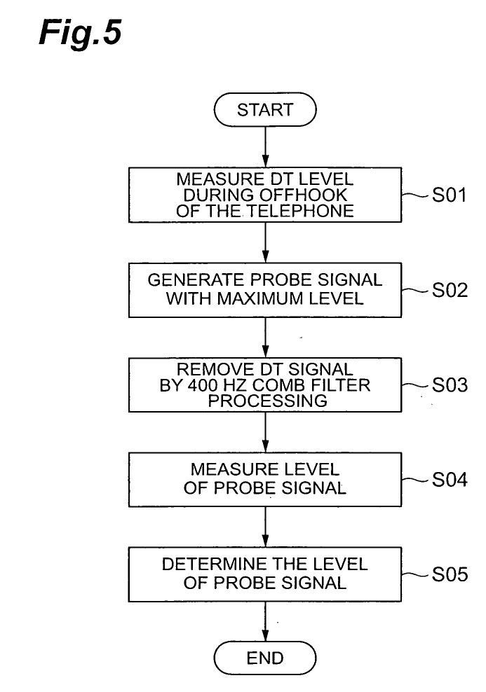

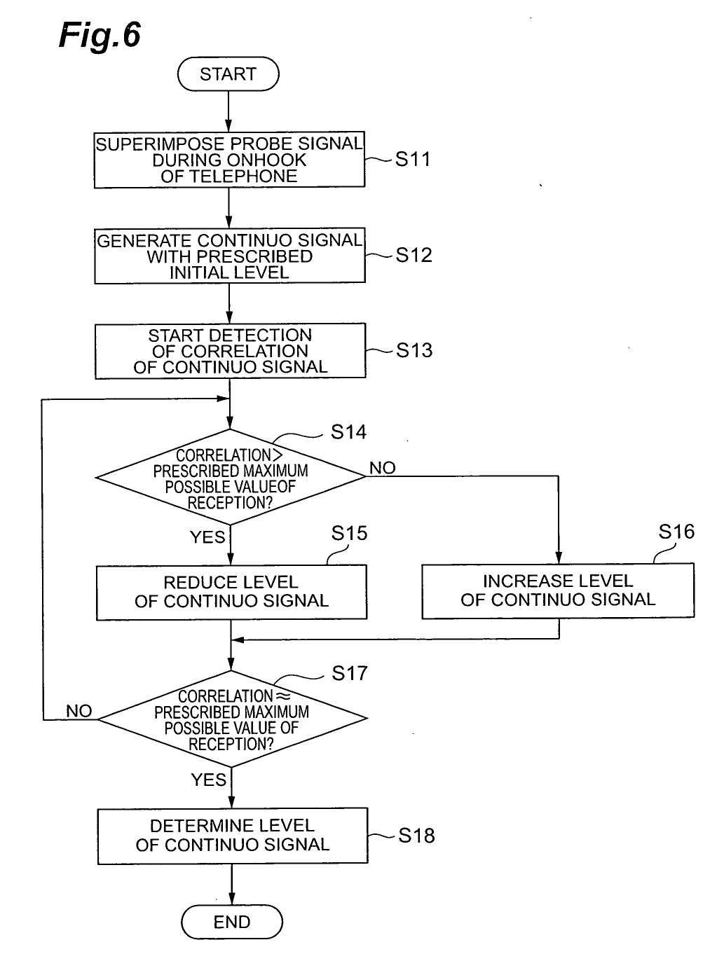

The transmission level determining unit 14 performs calibration process for setting the probe signal and the continuo signal level to suitable levels. FIG. 5 is a flow chart showing the calibration process that is performed in respect of the probe signal by the transmission level determining unit 14 and FIG. 6 is a flow chart showing the calibration process that is performed in respect of the continuo signal by the transmission level determining unit 14. The sequence of calibration process is described below.

As shown in FIG. 5, first of all, the transmission level determining unit 14 monitors the reception side communication circuit W3, and measures the level of the incoming DT (dial tone) signal from the switch (not shown) on the side of the telephone circuit W1 when the telephone is in offhook condition and sets this to a reference level (Step S01). Next, by controlling the transmission signal processing unit 11, the transmission level determining unit 14 causes a probe signal with the pre-set maximum level to be generated (Step S02). The received voice signal on which the probe signal has been superimposed is then monitored and the DT signal is removed (Step S03) from this monitored received voice signal by processing using a 400 Hz comb filter. In addition, the level of the received voice signal from which the DT signal has been removed is measured (Step S04). Finally, the level of the probe signal is set with reference to a reference level such that the level of the received voice signal is not harsh to the user and such that this level can still be detected, and the transmission signal processing unit 11 is controlled (Step S05) so as to generate a probe signal with this set level.

Next, referring to FIG. 6, the transmission level determining unit 14 causes a probe signal of the level set by the processing shown in FIG. 5 to be superimposed (Step S11) on the transmitted voice signal when the telephone 20 is in the onhook condition. Next, a continuo signal of the pre-set level is generated (Step S12) by controlling the amplifier unit 126 of the reception signal processing unit 12. After this, the transmission level determining unit 14 starts (Step S13) monitoring of the output level corresponding to the continuo signal that is output from the correlator 122 of the reception signal processing unit 12. The output level from the correlator 122 and the prescribed maximum value that can be received are then compared (Step S14), and if the output level exceeds the maximum value that can be received (Step S14: YES), the level of the continuo signal is decreased (Step S15) by controlling the reception signal processing unit 12. On the other hand, if the output level does not exceed the maximum value that can be received (Step S14: NO), the level of the continuo signal is increased (Step S16) by controlling the reception signal processing unit 12. When, as a result, the output level of the correlator 122 reaches (Step S17: YES) a level that is close to the maximum value that can be received, the level of the continuo signal is fixed (Step S18). In contrast, if the output level of the correlator 122 has not reached (Step S17: NO) a level that is close to the maximum value that can be received, processing returns to Step S14 and the adjustment (Steps S14 to S17) of the level of the continuo signal is repeated. By means of the calibration process as described above, the continuo signal can be set to a level at which fully satisfactory detection sensitivity can be maintained during onhook.

The beneficial effects of the call recording device 10 described above are described below.

With this call recording device 10, by superimposing a probe signal on the transmitted voice signal of the telephone 20, this probe signal leaks into the received voice signal as sidetone and, after demodulation of this received voice signal, the correlation of this demodulated signal with a replica code pattern corresponding to the probe signal is calculated, and the offhook condition is identified as being when this correlation is greater or equal a prescribed threshold value φₜₕ₁. Thus, recording process is executed in the offhook condition based on the result of this evaluation, so it is possible to accurately detect the onhook condition irrespective of the voice level in the call and change in the level of sidetone between the onhook condition and offhook condition can be reliably identified. In particular, since the probe signal continues to be supplied even during offhook, it is possible to continue to detect the offhook condition even if the voice is cut off during the call or if the voice level is small. Furthermore, even in cases where the internal circuitry is continually energizied in for example a telephone with a headset attachment, the difference in sidetone level that leaks back to the reception side communication circuit can be clearly distinguished. Also, by adopting a configuration connected to the transmission side communication circuit W2 and the reception side communication circuit W3 of the telephone 20, restrictions as to the type of telephone that can be used can be minimized.

Also, the correlation between the demodulated signal obtained by demodulation of the received digital signal and a replica code pattern that is the same as the spread spectrum code sequence is calculated after converting the received voice signal to the received digital signal, followed by superimposition of a continuo signal modulated using a spread spectrum code sequence on this received digital signal and the offhook condition is identified when the integrated value of this correlation is a prescribed threshold value φₜₕ₂ or below. Thanks to the additional employment of a continuo signal inserted in the circuitry on the reception side in this way, a drop in detection accuracy caused by received voice in the call in detection of the hook condition using a probe signal can be prevented.

Also, by employment of a signal that is modulated by spread spectrum modulation as the probe signal, an harsh effect on the received voice during the call can be avoided, and interference of the call voice with detection of the hook condition can be prevented.

Next, test results relating to detection of the hook condition in respect of a call recording device 10 according to an embodiment of the present invention will be described.

As the call recording device 10 used in the tests, a call recording device was employed with a frequency (chip frequency) per code bit of 1000 Hz, spread spectrum code period 1.023 sec, code sequence 1023 bit M sequence code, carrier frequency 2000 Hz, code synchronization system: fixed synchronization, maximum occupied frequency bandwidth: 977 Hz to 3023 Hz, sampling frequency 8000 Hz, voice data format: μ-Law or A-Law, voice frequency characteristic: 600 to 3,400 Hz (±4 dB) and S/N ratio about 42 dB.

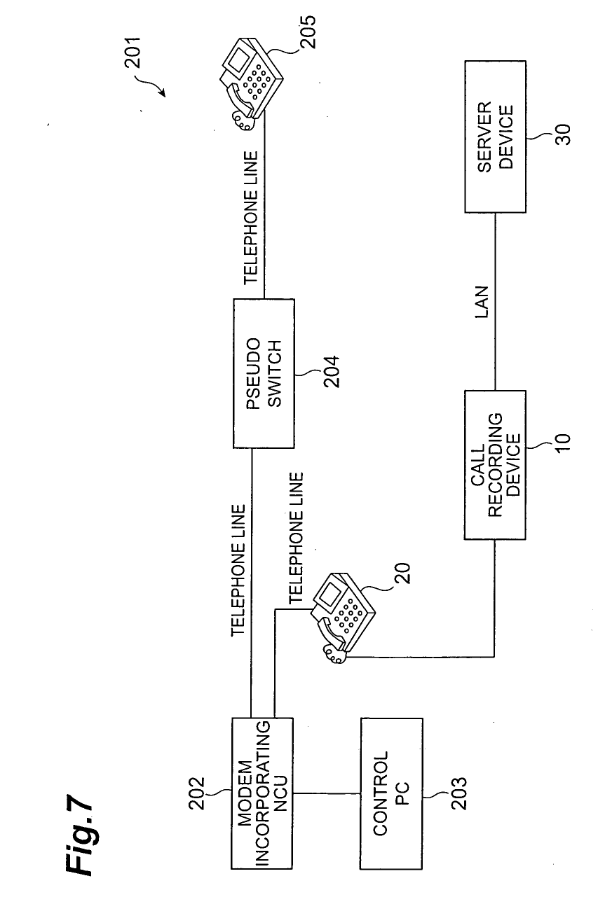

FIG. 7 shows the construction of a call recording system 201 employed in detection of the hook condition. As shown in this FIGURE, a control PC 203 that controls the call request operation using the NCU 202 is connected with a modem-incorporated NCU (Network Control Unit) 202. Also, the NCU 202 is connected with the telephone 20 through a telephone wire and is connected with a remote telephone 205 through a telephone wire and pseudo switch 204. After setting the hook condition of the telephone 20 in the offhook condition by means of 10 the incorporated relay switch, the NCU 202 repeatedly connects the telephone 20 and the remote telephone 205, setting an arbitrary duration of call. The NCU 202 sets the telephone 20 in the onhook condition immediately after termination of each call connection. During this process, the remote telephone 205 is set up to perform a function of answer phone, and recorded voice is transmitted in accordance with the duration of call. The measurement conditions in this test are shown in Table 1.

TABLE 1

| Call origination | Random (normal distribution, | |
|---|---|---|
| distribution condition | standard deviation 96) | |
| Average duration of call | 146 | sec |
| Central value of | 134 to 137 | sec |
| duration of call | | |
| Maximum value of | 963 | sec |
| duration of call | | |
| Minimum value of | 0 | sec |
| duration of call | | |
| Call interval | 5 | sec |

In this test using the call recording system 201, the test results shown in Table 2 were obtained by comparing the durations of call in accordance with the voice files accumulated on the server device 30 and the durations of call in accordance with the control log of the NCU 202 based on the call starting times. It was found that excellent hook detection could generally be achieved, irrespective of the type of telephone.

TABLE 2

| | Number of | Number | | |
|---|---|---|---|---|
| | calls with | of calls | | |
| | error kept | with error | Detection | Total |
| Type of | to less | of 5 sec or | success | number |
| telephone | than 5 sec | more | rate | of calls |
| Manufactured | 169 | 62 | 63% | 231 |
| by M Inc | | | | |
| Manufactured | 185 | 0 | 100% | 185 |
| by S Inc | | | | |

What is claimed is:

1. A call recording device that is connected with a telephone and that executes recording process of calls on this telephone comprising:
a transmission signal processing unit that is connected with the transmission side communication circuit of said telephone and that superimposes a probe signal modulated by a prescribed modulation method on a transmitted voice signal in said telephone;
a reception signal processing unit that is connected with the reception side communication circuit of said telephone, that monitors a received voice signal in said telephone, and that detects said probe signal included in said received voice signal, and decides the onhook/offhook condition of said telephone in accordance with the probe signal thus detected; and
a recording processing unit that executes recording process when it is decided by said reception signal processing unit that said telephone is in an offhook condition,
wherein said reception signal processing unit comprises:
a demodulator that demodulates said received voice signal;
a correlator that calculates a correlation value of the demodulated signal output by said demodulator and a replica signal corresponding to said probe signal generated by said transmission signal processing unit; and
a decision processing unit that decides that said telephone is in the offhook condition if the correlation that is output from said correlator is at least a prescribed threshold value.

2. The call recording device according to claim 1, wherein said reception signal processing unit further comprises: an analogue/digital converter that converts said received voice signal to a received digital signal; and a continuo signal generating unit that generates a continuo signal having a pre-derived code pattern and that modulates said continuo signal and superimposes the modulated signal on said received digital signal, said correlator further calculates the correlation value of said demodulated signal and said code pattern, and
said decision processing unit decides that said telephone is in the offhook condition if the correlation value that is output from said correlator is a prescribed second threshold value or below.

3. The call recording device according to claim 2, wherein said reception signal processing unit further comprises a threshold value control unit that, when said telephone is in the offhook condition, sets said second threshold value to a second value between the output level of said correlator during onhook and the present output level of said correlator.

4. The call recording device according to claim 1, wherein said probe signal is a signal that is modulated by spread spectrum modulation.
